(19) United States
(12) Patent Application Publication
(10) Pub. No.: US 2025/0328953 A1
(43) Pub. Date: Oct. 23, 2025

(54) SYSTEM AND METHOD FOR TOKENIZATION OF HYDROGEN-BASED LOW-CARBON FUELS AND CONTRACTS

(71) Applicants: Sumit D. Chowdhury, Presto, PA (US); Jay Vaidya, Mumbai (IN)

(72) Inventors: Sumit D. Chowdhury, Presto, PA (US); Jay Vaidya, Mumbai (IN)

(21) Appl. No.: 19/185,601

(22) Filed: Apr. 22, 2025

Related U.S. Application Data
(60) Provisional application No. 63/636,961, filed on Apr. 22, 2024.

(51) Int. Cl. G06Q 30/08; G06Q 30/0201

(52) U.S. Cl. CPC G06Q 30/08; G06Q 30/0206; G06Q 2220/165

(57) ABSTRACT

The present disclosure discloses a system and a method for tokenization of hydrogen-based low-carbon fuels (LCF) and contracts. The system comprises a server, one or more user devices, a database and a communication network. The server is configured to receive a request from a user using the user device for registration on a listing and trading platform. Further, the server is configured to generate tokens for one or more items corresponding to LCF molecules from inventory of the user for trading in market via the listing and trading platform. The server is further configured to store ownership of the tokens in the database when the transaction for the trade of the token is completed. The present disclosure is advantageous in terms of providing a safe, secure, transparent and verifiable system for tokenization of the LCF molecules.

### CROSS-REFERENCE TO RELATED APPLICATION

This application claims the benefit of U.S. Provisional Application Ser. No. 63/636,961, filed on Apr. 22, 2025, entitled “SYSTEM AND METHOD FOR TOKENIZATION, TRUST & TRACEABILITY OF THE LOW-CARBON HYDROGEN-BASED FUELS & CONTRACTS,” commonly assigned with this application and incorporated herein by reference in its entirety.

### FIELD OF DISCLOSURE

The present disclosure is generally related to a system and a method for tokenization of hydrogen based low-carbon fuel (LCF) molecules and contracts, and more particularly to the system and the method for tokenization of LCF molecules and contracts for allowing traceability of such tokens from production to retirement at the point of consumption and management of the tokens for the LCF molecule supply-chain.

### BACKGROUND

Hydrogen is the most abundant element in the universe. Therefore, hydrogen is being proposed to be used as an abundant source of clean energy. Hydrogen-based low-carbon fuels, including green hydrogen, green ammonia, e-methanol, sustainable aviation fuel (SAF), LNG and biofuels, have emerged as pivotal alternatives to carbon dioxide-emitting fossil fuels, crucial in mitigating climate change. These fuels are utilized in diverse sectors such as steel, fertilizer, transportation, and refineries, either as a blending component or a direct replacement for conventional fossil fuels.

Governments and financial sectors incentivize the production of hydrogen-based fuels, creating a burgeoning need for comprehensive tracking of the entire supply chain, from production and storage to transportation and consumption. Attracting Project Finance for Hydrogen plants also requires guarantee of demand. Simultaneously, the global market demands a standardized, certified, and globally accepted product to facilitate seamless trade. Without index-linked and tradeable contracts, both consumers and suppliers are reluctant to enter into long term agreements leading to lack of finance in setting up green hydrogen facilities. The current paper based bilateral agreement methods creates a deep opacity in the market.

There is an urgent need to have a system and a method to reduce risk of the financial markets by making the entire supply chain secure, visible and verifiable, while maintaining bilateral price confidentiality. There is also a need to making inventory and contracts valued at current market prices leading to improved balance-sheet value and further availability of finance.

### SUMMARY

A system for tokenization of hydrogen-based low-carbon fuels and contracts in accordance with the present disclosure comprises a server, one or more user devices, a database, and a communication network. The server, the one or more user devices and the database are configured to be communicatively coupled via the communication network. The server is configured to receive a request from a user using the user device for registration on a listing and trading platform. The server is further configured to receive inputs based on one or more items corresponding to a hydrogen-based low-carbon fuel (LCF) molecule selected by the user, based on an inventory of the user, on the listing and trading platform. Furthermore, the server is configured to generate, using a tokenization engine, a token for each of the items in the inventory. The server then determines using an RFQ engine and an auction engine, value of each token in market. Moreover, the server is configured to trade the tokens in the market via the listing and trading platform. The server also completes the transaction for a particular trade of the token between the user and a buyer, using a payment and settlement engine. Additionally, the server is configured to store ownership of the tokens in the database of the system.

In an embodiment of the present disclosure, the LCF molecule is selected from any one of a green hydrogen, a green ammonia, a sustainable aviation fuel (SAF), an e-methanol, a biofuel, and a liquified natural gas (LNG), and a combination thereof.

In an embodiment of the present disclosure, the tokens of different categories are generated based on stages of an LCF plant, the tokens are categorized as offtake tokens, financed tokens, production-ready tokens, produced tokens and retired tokens.

In an embodiment of the present disclosure, the tokens are configured to be stored on a block-chain to ensure trust and chain of custody of the tokens globally, for ensuring accurate and tamper-proof custodian services.

A method for tokenization of hydrogen-based low-carbon fuels and contracts in accordance with the present disclosure is illustrated. The method is configured to be performed on a system comprising a server, one or more user devices, a database and a communication network. The server, the one or more user devices, and the database are communicatively coupled via the communication network. The method comprising receiving by the server, a request from a user using the user device for registration on a listing and trading platform. The method further includes selecting by the user, using the user device, one or more items corresponding to a hydrogen-based low-carbon fuel (LCF) molecule based on an inventory of the user, on the listing and trading platform. Furthermore, the method comprises generating by the server, using a tokenization engine, a token for each of the items in the inventory. The method then involves determining by the server, using an RFQ engine and an auction engine, value of the tokens in market. Moreover, the method includes trading by the user, the tokens in the market via the listing and trading platform. Also, the method comprises completing by the server, using a payment and settlement engine, transaction for a particular trade of the token between the user and a buyer. Additionally, the method comprises storing by the server, ownership of the tokens in the database.

In an embodiment of the present disclosure, the one or more items in the inventory of the user may be selected from any one of physical assets and digital assets, wherein the physical asset correspond to the physical LCF molecule and the digital asset corresponds to an ownership of a future fungible asset

In an embodiment of the present disclosure, the method further comprises generating by the server, a contract token corresponding to each of the token that is generated for the LCF molecule based on the trade between the user and the consumer. The contract token comprises unique financial and commercial considerations between two parties in terms of multi-faceted smart-contract. Further, the contract tokens are interchangeable assets that can be traded on any participating exchange. Furthermore, the tokens are based on ERC-720 standard, and the contract tokens are based on ERC-721 standard.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an exemplary system for tokenization, trust, and traceability of hydrogen-based low-carbon fuels (LCF) and contracts in accordance with the present disclosure;

FIG. 2 illustrates an exemplary block diagram representing internal components of a server in accordance with the present disclosure;

FIG. 3 illustrates an exemplary block diagram for a processing unit of the server in accordance with the present disclosure;

FIG. 4 illustrates an exemplary flowchart representing categories of tokens based on stages of an LCF plant in accordance with the present disclosure; and

FIG. 5 illustrates an exemplary flowchart for a method of tokenization, trust, and traceability of hydrogen-based low-carbon fuels (LCF) and contracts in accordance with the present disclosure.

### LIST OF REFERENCE NUMERALS

100—System (e.g., Ethereum ecosystem)
102—one or more user devices
104—database
106—server
142—transceiver
144—memory
146—processing unit
302—tokenization engine
304—RFQ engine
306—auction engine
308—payment and settlement engine
402—offtake tokens
404—financed tokens
406—production-ready tokens
408—produced tokens
410—retired tokens
500—method

### DETAILED DESCRIPTION

Embodiments of the present disclosure are best understood by reference to the figures and description set forth herein. All the aspects of the embodiments described herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit and scope thereof, and the embodiments herein include all such modifications.

As used herein, the term “exemplary” or “illustrative” means “serving as an example, instance, or illustration.” Any implementation described herein as exemplary or illustrative is not necessarily to be construed as advantageous and/or preferred over other embodiments. Unless the context requires otherwise, throughout the description and the claims, the word “comprise” and variations thereof, such as “comprises” and “comprising” are to be construed in an open, inclusive sense, i.e., as “including, but not limited to.”

This disclosure is generally drawn, inter alia, to methods, apparatuses, systems, devices implemented as tools for tokenization, trust and traceability of Low-Carbon Hydrogen based fuels (LCF) and contracts.

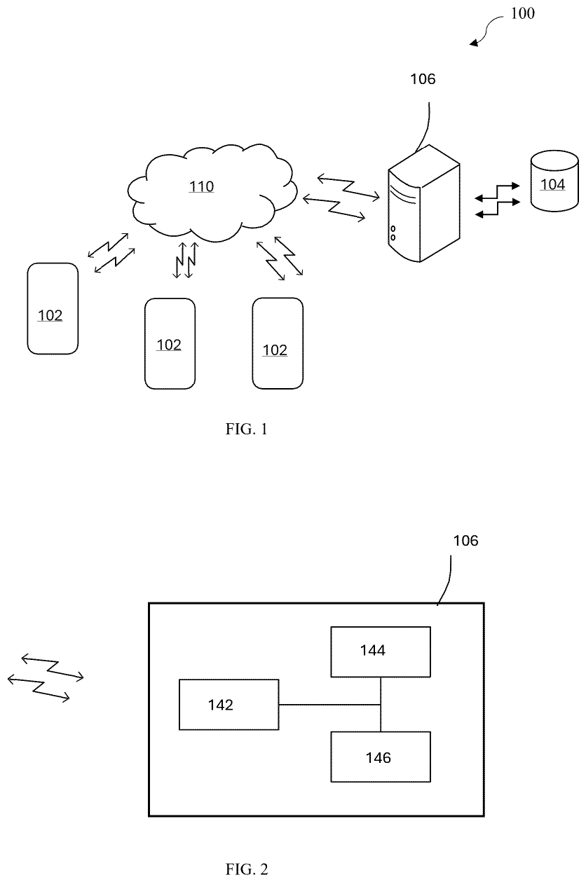

FIG. 1 illustrates an exemplary system 100 (e.g., Ethereum ecosystem) for tokenization, trust, and traceability of hydrogen-based Low-Carbon fuels (LCF) and contracts in accordance with the present disclosure. The system 100 (e.g., Ethereum ecosystem) comprises a server 106, one or more user devices 102, a database 104 and a communication network. The server 106, the one or more user devices 102, and the database 104 are communicatively coupled via the communication network. The server 106 is configured to receive a request from a user using the user device 102 for registration on a listing and trading platform. In an embodiment, the one or more user devices 102 corresponds to any one of producers, traders, suppliers, and sellers of LCF molecules. In an embodiment, the LCF molecule corresponds to a unit measure of the LCF molecule with a set of parameters that define the complete measured quantity of hydrogen. In another embodiment, the unit measure of the LCF molecule can be any quantity selected from 1 kg, 10 kg, 100 kg, and 1 metric ton. In yet another embodiment, the unit measure of the LCF molecule is 1 tonne (1 metric ton=1,000 kilograms). The server 106 is further configured to receive inputs from the user corresponding to one or more items for the LCF molecule based on an inventory of the user, on the listing and trading platform. The one or more items in the inventory of the user may be selected from any one of physical assets and digital assets. Further, the physical assets correspond to the physical LCF molecules and the digital asset corresponds to an ownership of a future fungible asset. In an embodiment, the LCF molecule is selected from any one of a green hydrogen, a green ammonia, a sustainable aviation fuel (SAF), an e-methanol, a biofuel, and a liquified natural gas (LNG), and a combination thereof. Furthermore, the server 106 is configured to generate, using a tokenization engine 302, a token for each of the items in the inventory. The server 106 is then configured to determine, using an RFQ engine 304 and an auction engine 306, a value of each token in market. Moreover, the server 106 is configured to trade the tokens in the market via the listing and trading platform. Thereafter, the server 106 is configured to complete, using a payment and settlement engine 308, a transaction of a particular trade of the token between the user and a buyer. Additionally, the server 106 is also configured to store, ownership of the token in the database 104.

In an embodiment of the present disclosure, the listing and trading platform tokenize the entire production capacity or part of the production capacity right from announcement of the LCF Plant. At this time the project developers uses this listing to seek off-takers who could be end-consumers, market aggregators or anyone else in the system 100 (e.g., Ethereum ecosystem) who would be willing to finance the plant in exchange for ownership of future produce of the plant. The legal link between the ownership of the token and the future ownership of the unit of measure of LCF Molecule is established through a globally enforceable legal contract.

In an embodiment, the server 106 is further configured to generate a contract token corresponding to each of the token that is generated for the LCF molecule based on the trade between the user and the buyer. The contract token comprises unique financial and commercial considerations between two parties in terms of multi-faceted smart-contract. Further, the contract tokens are interchangeable assets that can be traded on any participating exchange. Furthermore, the tokens are based on an ERC-720 standard, and the contract tokens are based on an ERC-721 standard. These contracts are also tokenized as multi-faceted diamond contracts and stored on the database 104.

In an embodiment of the present disclosure, the system 100 (e.g., Ethereum ecosystem) comprises tokenizing the Low Carbon Fuel (LCF) molecules on the blockchain, utilizing, but not limited to, two relevant Ethereum token standards: ERC-20 and ERC-721. The ERC-20 standard is used for creating fungible tokens, which are interchangeable and identical in value. Thereby making it suitable for representing standardized units or batches of LCF molecules, such as a defined quantity of a specific fuel type with uniform properties. Conversely, the ERC-721 standard defines non-fungible tokens (NFTs), where each token is unique and distinguishable. Thereby providing an ideal representation for the individual LCF molecules or fuel samples that vary based on factors like source, composition, production method, or carbon intensity score. Using these blockchain standards, the system allows for secure, transparent tracking and management of LCF molecules, supporting sustainability verification, regulatory compliance, and traceability in clean energy markets.

In an embodiment of the present disclosure, the server 106 is further configured to generate the token for a digital asset. Further, the digital asset is based on the ownership of a future fungible asset.

In an embodiment of the present disclosure, the tokens are configured to be stored on a block-chain to ensure trust and chain of custody of the tokens globally, for ensuring accurate and tamper-proof custodian services.

In an embodiment of the present disclosure, the tokens of different categories 400 are generated based on stages of an LCF plant, the tokens are categorized as offtake tokens 402, financed tokens 404, production-ready tokens 406, produced tokens 408 and retired tokens 410. In an embodiment, the stages of the LCF plant comprise project/planning stage, production stage, storage/transportation stage and consumption stage. In an embodiment, the ownership, relationship, and transformation of the tokens from the one stage to another stage is determined by a smart contract of a corresponding contract token and time bound rules for ensuring automation of the token supply-chain.

FIG. 2 illustrates an exemplary block diagram representing internal components of the server 106 in accordance with the present disclosure. The server 106 comprises a transceiver 142, a processing unit 146 and the database 104. The user devices 102 in the communication network transmits and receives data via respective transceiver 142s. The transceiver 142 of the server 106 is configured to transmit and receive data with the user devices 102 in the communication network. The processing unit 146 is configured to process the data before transmitting to the user device. The database 104 is a token registry. In an embodiment, the database 104 is configured to store the ownerships of the tokens and the multi-faceted smart-contract of the contract tokens. Further, the contract token comprises a legal link between the ownership of the token and the future ownership of a unit of the LCF Molecule through a globally enforceable legal contract. Some non-limiting examples of the one or more user devices 102 include laptop and desktop computers, smartphones and tablets and dedicated devices for communicating with the server 106.

Although illustrated as discrete components, various components may be divided into additional components, combined into fewer components, or eliminated while being contemplated within the scope of the disclosed subject matter. It will be understood by those skilled in the art that each function and/or operation of the components may be implemented, individually and/or collectively, by a wide range of hardware, software, firmware, or virtually any combination thereof. The system 100 (e.g., Ethereum ecosystem) components may be provided by one or more server 106 computers and associated components. According to an embodiment, the server 106 is configured to provide various functionalities of the present disclosure with execution of a set of instructions stored in a memory 144, by one or more processing units 146. Further, the server 106 communicates with the user devices 102 by the transceiver 142 using the network. The network can be different wired and wireless communication networks, such as Internet, Intranet, PSTN, Local Area Network (LAN), Wide Area Network (WAN), Metropolitan Area Network (MAN), and so forth. The information storage, retrieval, update, and such activities in such database 104 may be handled by the processing units.

In an exemplary embodiment of the present disclosure, the functionalities of the server 106 are implemented on a cloud network (e.g., cloud 110).

In an exemplary embodiment of the present disclosure, the user devices 102 are configured to execute an application. The application may be implemented as a software application or a combination of software and hardware. Further, the application installed in the user devices 102 is suitably configured to connect the user devices 102 with services offered by the server 106, and thus, the application allows the respective users of the user devices 102 to access the listing and trading platform of the system 100 (e.g., Ethereum ecosystem) for tokenization. In another exemplary embodiment, the user devices 102 are configured to access functionalities of the server 106 of the present disclosure using any one of a plurality of available browsers.

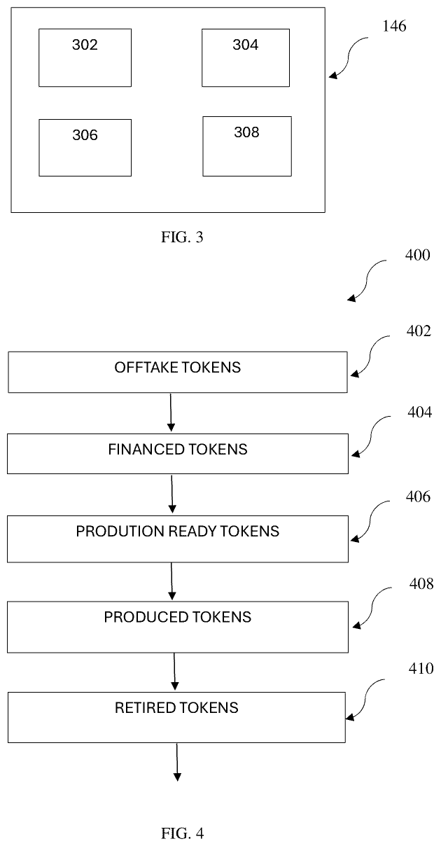

FIG. 3 illustrates an exemplary block diagram for the processing unit 146 of the server 106 in accordance with the present disclosure. The processing unit 146 comprises the tokenization engine 302, the RFQ engine 304, the auction engine 306 and the payment and settlement engine 308. The tokenization engine 302 is configured to generate the token for each item corresponding to the LCF molecule from the inventory of the user. The request for quote (RFQ) engine is configured to determine the value of the tokens in the market via inviting sellers to submit price quotes for the tokens of the LCF molecules. Further, the auction engine 306 is configured to determine the value of the token in the market via bidding in real time to eventually decide a winner based on price, time, or other criteria. Moreover, the payment and settlement engine 308, is configured to receive a payment instruction, validate user credentials, and initiate fund transfer via a payment gateway interface.

FIG. 4 illustrates an exemplary flowchart representing the categories of the tokens based on the stages of the LCF plant in accordance with the present disclosure. The tokens are categorized as offtake tokens 402, financed tokens 404, production ready tokens, produced tokens 408, and retired tokens 410. Further, all the categories of the tokens follow industry standard exchangeable formats such that they are portable across exchanges and can be owned. Furthermore, the stages of the LCF plants comprise project/planning stage, production stage, storage/transportation stage and consumption stage. Also, the ownership, relationship, and transformation of the tokens from one stage to another stage is determined by the smart contract of the corresponding contract token and time bound rules for ensuring automation of the token supply-chain. Further, based on a type and quantity of green energy planned, the tokens are issued to the producer to create the token for every unit of measure of the LCF Molecule. This molecule is planned, constructed, and produced, the token is independently traded between entities to eventually reach the consumer of the LCF molecule to produce a green product or to be used for transportation. On usage the LCF token is retired and can no longer be used a second time. Users from every part of the value chain can utilize the platform to produce and track the entire supply chain and provide authenticity to the certificate. Moreover, the offtake tokens 402 are the initial tokens that are minted during project/planning phase of the LCF plant. The financed tokens 404 are minted when the LCF plant has reached final investment decision (FID) in the project/planning stage. The financed tokens 404 are swapped for the offtake tokens 402 after the FID has reached. The production-ready tokens 406 correspond to the tokens that are minted during the production stage of the LCF plant. At this stage, the LCF plant completes construction, certification and is ready to begin producing fuel. Further, at the production stage, the financed tokens 404 are swapped for the production-ready token. The produced tokens 408 are minted when the LCF molecule is produced during the storage/transportation stage of the LCF plant. The production-ready tokens 406 are swapped for the produced tokens 408 when the LCF molecule is acquired by the buyer after the transportation of the LCF molecule to the storage of the buyer. The retired tokens 410 are minted during the consumption stage of the LCF plant. When the LCF molecules corresponding to the produced tokens 408 are consumed by the buyers/consumers, then the produced tokens 408 are swapped with the retired tokens 410 automatically. In an embodiment, the tokens at different stages are swapped using manual entries by the user/consumer, in an event of absence of detection of the stage of the LCF molecule. In another embodiment, the tokens are swapped using manual entries, when the consumer/buyer is not an end consumer.

In an embodiment of the present disclosure, digital conceptualization of the LCF plant creates a first opportunity to issue the offtake token 402 as planned quantities of LCF molecule and planned characteristics for specific target markets. The LCF tokens have a planned year of relating to when it is to be produced and sold.

In an embodiment of the present disclosure, when the LCF plant attains financial investment decision (FID), that is, once it has been financed and the decision to go ahead with construction is made, the token is converted into the financed token 404 with a mutually accepted process of refinement of characteristics. This conversion will lead to an appreciation of value as the risk is reduced for purchasers of the LCF molecule.

In an embodiment of the present disclosure, the financed tokens 404 have a life cycle from issuance till the plant owner provides a definitive month and date of completion of the plant construction and certification. It is converted to the production-ready token 406 with a mutually accepted process of refinement of characteristics. This conversion will also lead to an appreciation of value as the risk is further reduced for the marketplace.

In an embodiment of the present disclosure, the production-ready token 406 is automatically converted to the produced token 408 on the date of manufacture of the product with a definite take-or-pay date. These tokens are settled financially in whole on the date of lift-off from pipeline or storage unit of manufacturer.

In an embodiment of the present disclosure, physical delivery of hydrogen can happen in continuous flow in pipelines or using a store and forward basis. The on-site storage in each plant is a variable that needs to be tracked so that the molecule is delivered to another site, storage or pipeline before the on-site storage is full.

In an embodiment of the present disclosure, the storage/transportation stage is where the producer gets paid in full for the molecule and the physical ownership of the molecule is transferred. The token can be independently owned by a single party without any encumbrances. In an embodiment of the present disclosure, the consumer takes delivery and starts storing the hydrogen liability is transferred to the Consumer.

In an embodiment of the present disclosure, the produced token 408 is also converted in an LCF-Green Certificate (GC) token that is equivalent to the percentage of green energy used to create the LCF molecule. This ensures that the plant is efficient and continuously producing however not able to claim incentive or premium on the green decarbonization component. LCF-Green Certificate is only issued after verification of the contracts for procurement and use of green and clean energy resources. The molecule can be sold independently, and the green-certificate token will be sold independently and still always remains referenceable to a physical molecule token.

In an embodiment of the present disclosure, the produced token 408 is retired when it is purchased and settled by the end-consumer industry.

In an embodiment of the present disclosure, the LCF-GC token is retired when a downstream product producer i.e., steel producer, fertilizer producer, or transportation operator, buys the GC to claim the usage of the LCF molecules in their production process and claim carbon credits for the same.

In an embodiment of the present disclosure, primary users and potential owners of the LCF molecules are: a) hydrogen producer, b) market maker, c) hydrogen consumer, d) traders/brokers, and e) banks and institutional users. Further, the Hydrogen Producer—the promoter and developer of the plant who is considered the ultimate manufacturer and has rights to sell the manufactured molecule. It could be an existing company or a new company that has been formed. The original offtake tokens 402 are issued to the producer. The Market Maker—the aggregator who enters into the initial marketing or purchasing agreement with the hydrogen producer to ensure that the molecule produced is taken up on or shortly after the production date. The market maker may ultimately sell the product to other traders or to end consumers of hydrogen. The Hydrogen Consumer—The ultimate user of Green Hydrogen or just regular Hydrogen molecules to be used for any purpose like refinery, steel, shipping, aviation, fuel cell for trucks, fertilizers, or any other purpose. They will retire the molecule token and, also retire the independent green token. Traders/Brokers—This group of users will own the tokens or buy and sell it on behalf of other clients. The Traders will never keep the option to produce or consume the molecule or take responsibility for actual asset handling. Banks and Institutional Users: These users will validate companies and the initial tokens and allow it to be owned and traded. They will finance the plant and also provide the financial backing to Market Makers and Traders to secure future inventory.

In an embodiment of the present disclosure, as the certainly of production and date of production nears, it is expected that the value of the token will increase and provide a partial or complete exit opportunity to owners of tokens.

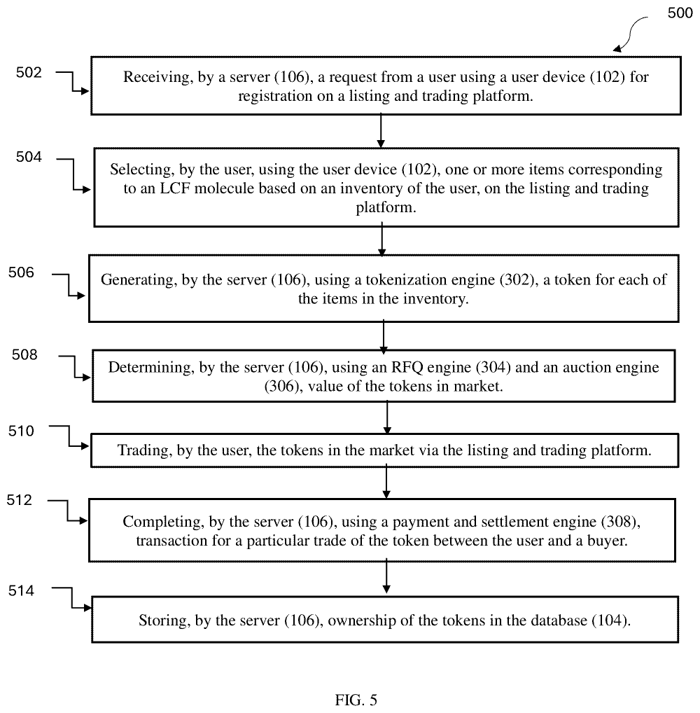

FIG. 5 illustrates an exemplary flowchart for a method 500 of tokenization, trust, and traceability of the hydrogen-based low-carbon fuels (LCF) and contracts in accordance with the present disclosure. The method 500 is configured to be performed on the system 100 (e.g., Ethereum ecosystem) comprising the server 106, the one or more user devices 102, the database 104 and the communication network. The server 106, the one or more user devices 102, the database 104 and the communication network are communicatively coupled via the communication network. The method 500 comprising the following steps:

In step 502, the method 500 comprises receiving by the server 106, a request from the user using the user device 102 for registration on the listing and trading platform. The listing and trading platform is provided on the user interface of the one or more user devices 102 requesting access to the system 100 (e.g., Ethereum ecosystem) for tokenization. Further, the one or more user devices 102 corresponds to any one of producers, traders, suppliers, and sellers of the LCF molecule.

In step 504, the method 500 includes selecting by the user, using the user device, the one or more items corresponding to the hydrogen-based low-carbon fuel (LCF) molecule based on the inventory of the user on the listing and trading platform. The one or more items in the inventory of the user may be selected from any one of physical assets and digital assets. Further, the physical assets correspond to the physical LCF molecules. In an embodiment of the present disclosure, the method 500 further comprises generating by the server 106 the token for the digital asset. Further, the digital assets are based on the ownership of the future fungible asset. Furthermore, the LCF molecule is selected from any one of a green hydrogen, a green ammonia, a sustainable aviation fuel (SAF), an e-methanol, a biofuel, and a liquified natural gas (LNG), and a combination thereof.

In step 506, the method 500 comprises generating by the server 106, using the tokenization engine 302, the token for each of the items in the inventory. The tokenization engine 302 is configured to generate the tokens for each of the item corresponding to the LCF molecule from the inventory of the user.

In an embodiment of the present disclosure, the tokens of different categories are generated based on the stages of the LCF plant, the tokens are categorized as offtake tokens 402, financed tokens 404, production-ready tokens 406, produced tokens 408 and retired tokens 410. Further, the stages of the LCF plant comprise project/planning stage, production stage, storage/transportation stage and consumption stage. Furthermore, the ownership, relationship, and transformation of the tokens from the one stage to another stage is determined by the smart contract of the corresponding contract token and the time bound rules for ensuring the automation of the token supply-chain.

In step 508, the method 500 involves determining by the server 106, using the request for quote (RFQ) engine 304 and the auction engine 306, the value of the tokens in the market. The RFQ engine 304 is configured to determine the value of the tokens in the market via inviting sellers to submit price quotes for the tokens of the LCF molecules. Furthermore, the auction engine 306 is configured to determine the value of the token in the market via bidding in real time to eventually decide a winner based on price, time, or other criteria.

In step 510, the method 500 includes trading by the user, the tokens in the market via the listing and trading platform. The trading of the token comprises selling the tokens to buyers at reasonable prices and/or maximum prices. Further, the buyers may comprise market makers, and consumption industries.

In step 512, the method 500 comprises completing, by the server 106, using the payment and settlement engine 308, the transaction for the particular trade of the token between the user and the buyer. The payment and settlement engine 308, is configured to receive the payment instructions, validate user credentials, and initiate fund transfer via the payment gateway interface. After the completion of the transaction, the ownership of the token is transferred from the user to the buyer.

In step 514, the method 500 comprises storing by the server 106, the ownership of the tokens in the database 104. The ownership of the token for the buyer is stored in the database 104 Further, the database 104 is the token registry. Further, the database 104 of the system 100 (e.g., Ethereum ecosystem) is configured to store the ownerships of the tokens and the multi-faceted smart-contracts of the contract tokens.

In an embodiment of the present disclosure, the green tokens are verified only when the corresponding green-token has been retired by the consumer. This ensures that Green-tokens cannot be reused many times.

In an embodiment of the present disclosure, the method 500 further comprises generating by the server 106, the contract tokens corresponding to each of the token that is generated for the LCF molecule based on the trade between the user and the consumer. The contract token comprises unique financial and commercial considerations between two parties in terms of multi-faceted smart-contract. Further, the tokens are based on the ERC-720 standard, and the contract tokens are based on the ERC-721 standard.

In the embodiment of the present disclosure, the contracts for fuel trade are developed as the Diamond Multi Facet Strategy developed in the system 100 (e.g., Ethereum ecosystem). ERC-2535: Diamonds, Multi-Facet Proxy. This allows the platform to create modular digital contract systems that can be extended after deployment. The Upgradeable Diamond contracts provide multiple advantages or databases 104, including a Centralized Database. Decentralized Autonomous Organizations (DAOs) and other governance systems can be used to control token upgrades and trade. There will be wide interaction and integration with the system 100 (e.g., Ethereum ecosystem) when required. With open storage data and verified source code it is possible to show a verified history. In addition, bad behavior can be spotted and reported, and independent security and domain experts can review the history of contracts and vouch for their trustworthiness. It is also possible for an upgradable diamond to become immutable so that contract terms cannot be removed, and trust less, such that each contract can be verified without disclosing all aspects of the contract.

In an embodiment of the present disclosure, the Green Certificates are ERC-721 tokens issued to producers who satisfy certain sustainability conditions during production. Any good or service traded in the modern economy has an environmental footprint, which may be positive, neutral or negative. This footprint covers a variety of areas, such as carbon emissions, water use, land use, etc. Green Certificates store data related to this environmental footprint for the corresponding fuel token. Therefore, if a particular ton of fuel has been produced with a very small environmental footprint, its corresponding green certificate will contain the data required to prove this. Green Certificates can be sold to participants in the market.

In an embodiment of the present disclosure, the green certificate contracts will use the Interplanetary File System (IPFS) and a one-time use function to generate a report on the environmental impact of the production of a given lot of LCF molecules. These reports are tied strongly to the time and purpose of generation. This information is publicly verified on the green certificate.

Bank Guarantee or Escrow Tokens: Each contract will be backed by margin money and bank guarantees to provide counter party risks. These bank guarantees will also be stored on the platform as tokens and will be associated with Smart Contracts. The Bank Guarantee tokens will be monitored for validity, amount and expiry dates. As the value of the underlying assets will keep changing, the application is expected to prompt the user to increase or reduce the value of the Bank Guarantee to match the risk profile of the owner of the token/molecule/contract.

Accordingly, the system 100 (e.g., Ethereum ecosystem) for tokenization of hydrogen-based low-carbon fuels (LCF) and contracts is advantageous in terms of providing a transparent, efficient, secure, flexible and economically fair system 100 (e.g., Ethereum ecosystem) for the participants in the value chain. The conventional systems are fungible and have batch-based fuel representation. The existing certification systems treat green fuels as interchangeable, relying on minimal metadata like origin or production method. This oversimplifies key environmental differences such as carbon intensity, renewable inputs, and site-specific emissions, making it hard to distinguish fuels with significantly different climate impacts. Further, the current system 100 (e.g., Ethereum ecosystem) provides static, inflexible offtake contracts which are paper-based, bilateral and rigid agreements. Once executed, they are difficult to modify, subdivide, or transfer. Furthermore, the green fuels market (e.g., hydrogen, SAF) lacks a centralized, transparent platform for buyers and sellers to access real-time supply, demand, or price benchmarks. Also, buyers have limited transparency into how, where, or when green fuels are produced, undermining trust and carbon claims. Traditional offtake contracts are inflexible, costly to manage, and inaccessible to smaller players. Environmental benefits are tied to physical fuel delivery, forcing inefficient logistics (e.g., importing green hydrogen to claim sustainability credits). Hence, the present disclosure is advantageous in terms of providing the system 100 (e.g., Ethereum ecosystem) and the method 500 for tokenization to overcome the drawbacks in the prior art systems. The system 100 (e.g., Ethereum ecosystem) provides a real-time digital marketplace that increases market visibility and unlocks smarter decision-making by offering live pricing and supply insights, regional availability mapping and integrated certification data. Thereby empowering buyers and sellers to act with confidence and speed in a fragmented market. Further, the present disclosure comprises providing a unique digital token to each metric ton of the LCF molecule, to provide a production method 500, renewable energy input, date and location, carbon intensity. Furthermore, this granular traceability supports auditable ESG claims, enabling compliance, credibility, and differentiation in green fuel procurement. Moreover, the system 100 (e.g., Ethereum ecosystem) introduces standardized, tokenized offtake agreements at the 1T level, delivering fractional ownership and re-sell ability, reduced legal complexity, cost, greater participation for SMEs, and new entrants. Thereby, unlocking a more liquid, inclusive, and dynamic green fuel market. Additionally, the virtual trading of green attributes (e.g., Guarantees of Origin, Sustainability Certificates), allowing local use of conventional fuel, global transfer of verified green value, streamlined decarbonization accounting. This creates logistical flexibility, reduces costs, and accelerates net-zero outcomes across borders. The present disclosure provides a token-based system 100 (e.g., Ethereum ecosystem) for the LCF molecules. The tokens can be bundled, split, or restructured, thereby allowing dynamic reallocation, flexible offtake arrangements and scalable market participation. The smart contract logic of the contract tokens allows for royal enforcement, thereby re-selling tokens at a premium in secondary markets, with original producer receiving a predefined share. Also, the system 100 (e.g., Ethereum ecosystem) for tokenization represents tokens as physical green fuel or green attributes, thereby enabling decoupled trading and allowing global transfer of certified green value, local consumption of grey fuel and efficient compliance and decarbonization accounting.

Although the present disclosure has been described in terms of certain preferred embodiments, various features of separate embodiments can be combined to form additional embodiments not expressly described. Moreover, other embodiments apparent to those of ordinary skill in the art after reading this disclosure are also within the scope of this disclosure. Furthermore, not all the features, aspects and advantages are necessarily required to practice the present disclosure. Thus, while the above detailed description has shown, described, and pointed out novel features of the disclosure as applied to various embodiments, it will be understood that various omissions, substitutions, and changes in the form and details of the apparatus or process illustrated may be made by those of ordinary skill in the technology without departing from the spirit of the disclosure. The disclosures may be embodied in other specific forms not explicitly described herein. The embodiments described above are to be considered in all respects as illustrative only and not restrictive in any manner.

1. A system for tokenization of hydrogen-based low-carbon fuels (LCF) and contracts, the system comprises a server, one or more user devices, a database, and a communication network, wherein the server is configured to:
receive, a request from a user using the user device for registration on a listing and trading platform, wherein the server is further configured to receive inputs from the user based on one or more items from an inventory of the user, on the listing and trading platform, the one or more items corresponds to a hydrogen-based low-carbon fuel (LCF) molecule;
generate, using a tokenization engine, a token for each of the items of the inventory on the listing and trading platform;
determine, using an RFQ engine and an auction engine, value of each of the tokens in market;
trade, the tokens in the market using the listing and trading platform;
complete, using a payment and settlement engine, a transaction for a particular trade of the token between the user and a buyer; and
store, ownership of the token in the database, wherein the server, the one or more user devices, and the database are configured to be communicatively coupled via the communication network.

2. The system of claim 1, wherein the one or more items in the inventory of the user may be selected from any one of physical assets and digital assets, wherein at least one physical asset corresponds to the physical LCF molecule and at least one digital asset corresponds to an ownership of a future fungible asset.

3. The system of claim 1, wherein the one or more user devices corresponds to any one of producers, traders, suppliers and sellers of the LCF molecules.

4. The system of claim 1, wherein the LCF molecule is selected from any one of a green hydrogen, a green ammonia, a sustainable aviation fuel (SAF), an e-methanol, a biofuel, and a liquified natural gas (LNG), and a combination thereof.

5. The system of claim 1, wherein the server is further configured to generate a contract token corresponding to each of the token that is generated for the LCF molecule based on the trade between the user and the buyer, the contract token comprises unique financial and commercial considerations between two parties in terms of multi-faceted smart-contract, wherein the tokens are based on ERC-720 standard and the contract tokens are based on ERC-721 standard.

6. The system of claim 1, wherein the tokens are configured to be stored on a block-chain to ensure trust and chain of custody of the tokens globally, for ensuring accurate and tamper-proof custodian services.

7. The system of claim 1, wherein the tokens of different categories are generated based on stages of an LCF plant, the tokens are categorized as offtake tokens, financed tokens, production-ready tokens, produced tokens and retired tokens.

8. The system of claim 7, wherein the stages of the LCF plant comprise project/planning stage, production stage, storage/transportation stage and consumption stage.

9. The system of claim 7, wherein the ownership, relationship and transformation of the tokens from the one stage to another stage is determined by a smart contract of a corresponding contract token and time bound rules for ensuring automation of a token supply-chain.

10. A method for tokenization of hydrogen-based low-carbon fuel (LCF) and contracts, the method is configured to be performed on a system comprising a server, one or more user devices, a database and a communication network, the method comprising:
receiving, by the server, a request from a user using the user device for registration on a listing and trading platform;
selecting, by the user, using the user device, one or more items corresponding to a hydrogen-based low-carbon fuel (LCF) molecule based on an inventory of the user, on the listing and trading platform;
generating, by the server, using a tokenization engine, a token for each of the items in the inventory;
determining, by the server, using an RFQ engine and an auction engine, value of each of the tokens in market;
trading, by the user, the tokens in the market via the listing and trading platform;
completing, by the server, using a payment and settlement engine, a transaction for a particular trade of the token between the user and a buyer; and
storing, by the server, ownership of the tokens in the database, wherein the server, the one or more user devices and the database are communicatively coupled via the communication network.

11. The method of claim 10, wherein the one or more items in the inventory of the user may be selected from any one of physical assets and digital assets, wherein the physical asset correspond to a physical LCF molecule and the digital asset corresponds to an ownership of a future fungible asset.

12. The method of claim 10, wherein the one or more user devices corresponds to any one of producers, traders, suppliers and sellers of the LCF molecules.

13. The method of claim 10, wherein the LCF molecule is selected from any one of a green hydrogen, a green ammonia, a sustainable aviation fuel (SAF), an e-methanol, a biofuel, and a liquified natural gas (LNG), and a combination thereof.

14. The method of claim 10, wherein the method further comprises generating by the server, a contract token corresponding to each of the token that is generated for the LCF molecule based on the trade between the user and a consumer, the contract token comprises unique financial and commercial considerations between two parties in terms of multi-faceted smart-contract, wherein the tokens are based on ERC-720 standard and the contract tokens are based on ERC-721 standard.

15. The method of claim 10, wherein the tokens are configured to be stored on a block-chain to ensure trust and chain of custody of the tokens globally, for ensuring accurate and tamper-proof custodian services.

16. The method of claim 10, wherein the tokens of different categories are generated based on stages of an LCF plant, the tokens are categorized as offtake tokens, financed tokens, production-ready tokens, produced tokens and retired tokens.

17. The method of claim 16, wherein the stages of the LCF plant comprise project/planning stage, production stage, storage/transportation stage and consumption stage.

18. The method of claim 16, wherein the ownership, relationship and transformation of the tokens from the one stage to another stage is determined by a smart contract of a corresponding contract token and time bound rules for ensuring automation of a token supply-chain.
